(19) United States
(12) Patent Application Publication
(10) Pub. No.: US 2007/0162631 A1
(43) Pub. Date: Jul. 12, 2007

(54) Method for selectable software-hardware internet SCSI

(75) Inventors: Ganesh Balakrishnan, Morrisville, NC (US); Jorge R. Rodriguez, Cary, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/319,852

(22) Filed: Dec. 28, 2005

(51) Int. Cl. G06F 3/00

(52) U.S. Cl. 710/15

(57) ABSTRACT

Embodiments of the present invention address the deficiencies of the art in respect to application performance and provide a novel and non-obvious data processing method, system and computer program product for selecting between separate hardware implemented and software implemented iSCSI paths to process an input/output request in a data communication environment. In one embodiment, a method for selecting between separate hardware implemented and software implemented iSCSI paths to process an input/output request can include transmitting a stream of requests to access at least one logical block address in at least one storage device in an IP storage system is provided. The utilization of a first processor in a host configured to transmit the stream of requests, where the host provides a first iSCSI implementation can be monitored along with the utilization of a second processor in an adapter coupled to the storage device, where the adapter provides a second iSCSI implementation. In addition, a request in the stream of requests can be routed to the first iSCSI implementation in the host and the second iSCSI implementation in the adapter based upon a value of the utilization of the first processor in the host and a value of the utilization of the second processor in the adapter. The first iSCSI implementation can be a software iSCSI and the second iSCSI implementation can be a hardware iSCSI.

### BACKGROUND OF THE INVENTION

1. Statement of the Technical Field

The present invention relates to data communications over networks and more particularly to Internet SCSI (iSCSI) data transmissions.

2. Description of the Related Art

In the context of computer storage, Internet Small Computer System Interface (iSCSI) is a transmission control protocol/internet protocol (TCP/IP)-based protocol for establishing and managing connections among IP-based storage devices, hosts and clients. iSCSI enables any machine on an IP network, referred to as an initiator, to contact a remote dedicated server, referred to as a target, and perform block input/output (I/O) on the target just as the initiator would perform block I/O with a local hard disk.

iSCSI supports a Gigabit Ethernet interface at the physical layer, which allows systems supporting iSCSI interfaces to connect directly to standard Gigabit Ethernet switches and/or IP routers. When an operating system (OS) receives a request, the OS generates the SCSI command and then sends an IP packet over an Ethernet connection. At the receiving end, the SCSI commands are separated from the request, and the SCSI commands and data are sent to the SCSI controller and then to the SCSI storage device. iSCSI also will return a response to the request using the same protocol.

One significant drawback of the iSCSI protocol is the relatively long latency—close to seventy-five (75) microseconds—for Ethernet based storage area networks because of the overhead of the TCP/IP stack. In particular, the TCP/IP protocol of the TCP/IP stack adds significant overhead to the communication between client and storage. Thus, the use of software processing alone, for instance on a host, can result in little or no processing resources left for the application to run on the host. This can be a crucial problem in high-end systems in those cases of simultaneous access to thousands of files.

One technique used to reduce the overhead is TCP Offload Engine (TOE), which is a technology for the acceleration of TCP/IP by moving TCP/IP processing to a separate dedicated sub-system, for instance a host bus adapter (HBA), from the main host thereby improving the overall system TCP/IP performance. Another potential technique to reduce the TCP overhead includes the definition of the TCP/IP functionality partially in software and partially in hardware to form a single hybrid software/hardware pathway. However, neither the TOE approach nor the all software approach, the all hardware approach, nor the software/hardware pathway approach can provide a more optimal performance enhancement for various application workloads.

### BRIEF SUMMARY OF THE INVENTION

Embodiments of the present invention address the deficiencies of the art in respect to application performance and provide a novel and non-obvious data processing method, system and computer program product for selecting between separate hardware implemented and software implemented iSCSI paths to process an input/output request in a data communication environment. In one embodiment, a method for selecting between separate hardware implemented and software implemented iSCSI paths to process an input/output request can include transmitting a stream of requests to access at least one logical block address in at least one storage device in an IP storage system is provided. The utilization of a first processor in a host configured to transmit the stream of requests, where the host provides a first iSCSI implementation can be monitored along with the utilization of a second processor in an adapter coupled to the storage device, where the adapter provides a second iSCSI implementation. In addition, a request in the stream of requests can be routed to the first iSCSI implementation in the host and the second iSCSI implementation in the adapter based upon a value of the utilization of the first processor in the host and a value of the utilization of the second processor in the adapter. The first iSCSI implementation can be a software iSCSI and the second iSCSI implementation can be a hardware iSCSI.

The data input/output request processing method can further include determining if the first processor in the host is fully utilized, and if so, whether the second processor in the adapter is fully utilized. If the second processor is not fully utilized, the requests can be routed to the adapter to be serviced by the second iSCSI implementation. Alternatively, even when the first processor in the host is not fully utilized, a determination of whether the second processor in the adapter is fully utilized can be performed and if the second processor is not fully utilized, the requests can be routed to the adapter to be serviced by the second iSCSI implementation. In this embodiment, the requests can be routed to the host to be serviced by the first iSCSI implementation when the first processor in the host is not fully utilized but the second processor in the adapter is fully utilized. Finally, the value of the utilization of the first processor in the host can be based upon a value of utilization of a processor in an Ethernet network interface card.

In another embodiment, a data input/output request processing system for selecting between separate hardware implemented and software implemented iSCSI paths to process an input/output request can include a host; and iSCSI monitor control logic coupled to the host wherein the iSCSI monitor control logic includes program code enabled to select between separate hardware implemented and software implemented iSCSI paths to process an input/output request. The system further can include an adapter coupled to the host to provide a hardware iSCSI path.

Additional aspects of the invention will be set forth in part in the description which follows, and in part will be obvious from the description, or can be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing network for selecting between separate hardware implemented and software implemented iSCSI paths to process an input/output request;

FIG. 2 is a block diagram of the iSCSI protocol layers including an application layer and an iSCSI monitor layer; and,

FIG. 3 is a flow chart illustrating a process for selecting between separate hardware implemented and software implemented iSCSI paths to process an input/output request of FIG. 1.

### DETAILED DESCRIPTION OF THE INVENTION

Embodiments of the present invention provide a method, system and computer program product for selecting between separate hardware implemented and software implemented iSCSI paths to process an input/output request in a data communication environment. In accordance with an embodiment of the present invention, a first processor in a host configured to transmit a stream of requests can be monitored; a second processor in an adapter coupled to a storage device can be monitored. Through the monitoring, the utilization of each processor can be determined. Consequently, the requests in the stream of requests can be routed either through a software iSCSI path or a hardware iSCSI path based upon the values of the two processor utilizations.

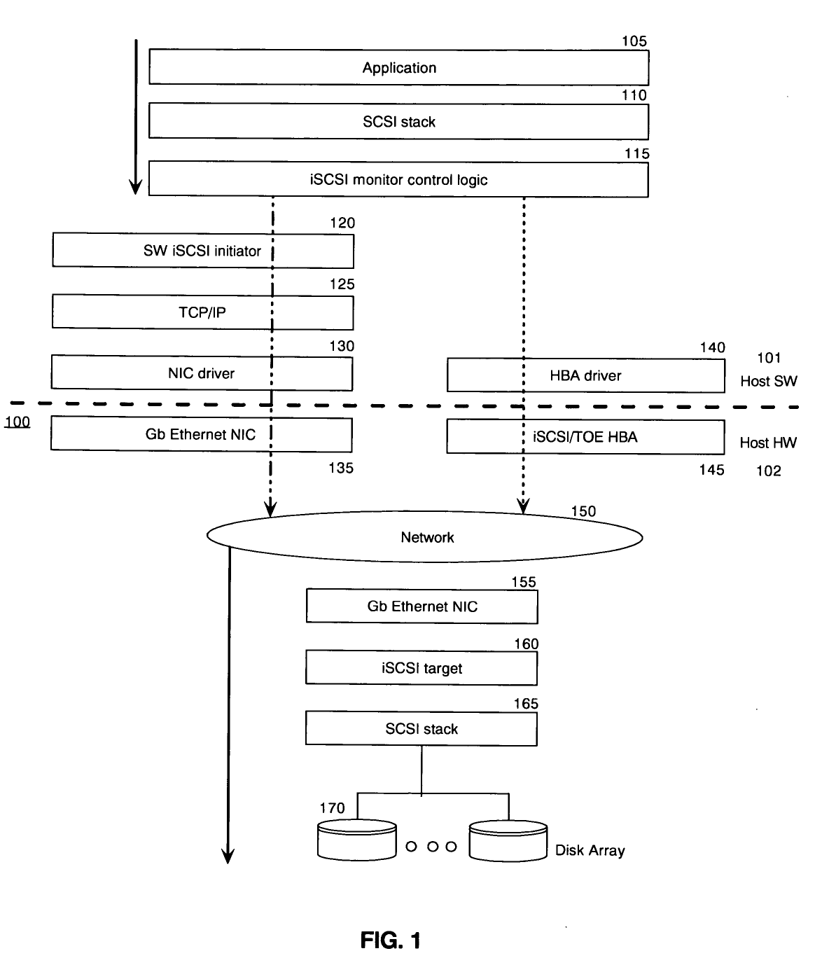

In further illustration, FIG. 1 is a schematic illustration of a data processing network for selecting between separate hardware implemented and software implemented iSCSI paths to process an input/output request. The data processing network can include one or more hosts 100, for example a client workstation, communicatively coupled to one or more data storage devices 170 utilizing iSCSI protocols in a network 150. Various applications 105 can run on a host computer 100, however these applications can be either CPU-bound (CPU-limited) or I/O-bound (throughput-limited). For example, a file server's performance (workload) is generally driven by I/O bandwidth, while a web server's workload usually is driven by CPU bandwidth. For those cases where the application can be I/O-bound, a software (SW) iSCSI implementation (120, 125, 130 and 135) can prove more beneficial. In contrast, for those cases where the application can be CPU-bound; a hardware (HW) iSCSI implementation (140 and 145) can prove more beneficial. In this embodiment, the software iSCSI refers to a software implementation of iSCSI executing almost completely in the host processor 101, except for those functions that are typically included in the Network Interface Controller (NIC) 135, such as computation of Cyclic Redundancy Check (CRC) and interrupt coalescence. The hardware (HW) iSCSI or (iSCSI/TOE) refers to an iSCSI implementation in firmware executing in the iSCSI/TOE in a Host Bus Adapter (HBA) 145. The processing function of the HBA 145 can be provided by various electronic devices including application specific integrated chips (ASIC), field programmable gate array (FPGA) and packet processor chips.

The iSCSI monitor control logic 115 can be an adaptive algorithm that monitors certain performance parameters of both the host processor 101 and the HBA iSCSI processor 145 and routes I/O requests to a “preferred” path (e.g., HW iSCSI or SW iSCSI) to enhance overall system performance. The iSCSI monitor control logic 115 can be disposed within or in association with the host software as shown in FIG. 1, or with the HBA adapter 145, or Gb Ethernet Network Interface Card (NIC) 135. For those cases where performance is enhanced through simultaneous use of both the HW iSCSI path and the SW iSCSI path, a concept of a “mirrored” session is introduced. During a mirrored session, a single session is maintained at the iSCSI level, but independent TCP connections are created during a session establishment phase, one through the SW iSCSI path and another through the HW iSCSI path.

To facilitate the application of the iSCSI monitor control logic 115 selection function, the operating systems, or processing logic of the Gb Ethernet NIC card 135 and the HBA iSCSI/TOE 145 can be coupled to the iSCSI monitor control logic 115. These operating systems typically can provide counters to convey the utilization of the host CPU 101 and the HBA processor 145.

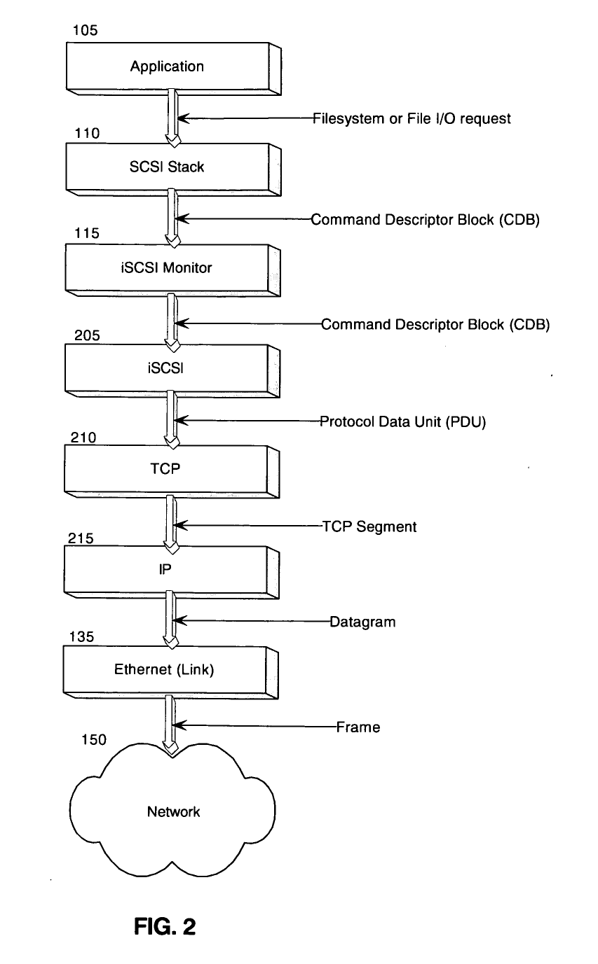

Now referring to the block diagram of FIG. 2, which illustrates the iSCSI protocol layers including an application layer and an iSCSI monitor control logic layer. In operation, the application 105 can issue a filesystem or disk command to the SCSI stack layer 110, which then encapsulates the command into a command descriptor block (CDB). The iSCSI monitor control logic 115 can monitor the various system parameters (e.g., the counters of the various processors) and determines whether to route the encapsulated CDB to the SW iSCSI path (which can include SW iSCSI initiator 120, TCP/IP 125, NIC driver 140, and Gb Ethernet NIC card 135) or to the HW iSCSI path (which can include HBA driver 130, and HBA iSCSI/TOE 145), as illustrated in FIG. 1.

In either event, the encapsulated CDB can be serialized by the iSCSI command of layer 205 which can result in a protocol data unit (PDU). The TCP protocol is provided at layer 210 which can result in a TCP segment, which in turn, can be converted into a datagram at the IP layer 215. Finally, the Ethernet (link) layer 135 is applied to produce a frame for transmission over a network 150. When the SW iSCSI path is selected, the host CPU 101 can process layers one through layer six, while the Gb Ethernet NIC 135 can process layer seven. However with the HW iSCSI path is chosen, the host CPU 101 can process layers one through layer three, while the HBA adapter 145 can process layers four through seven. Accordingly the selection of the HW iSCSI path can free up valuable processing bandwidth on the host CPU 101.

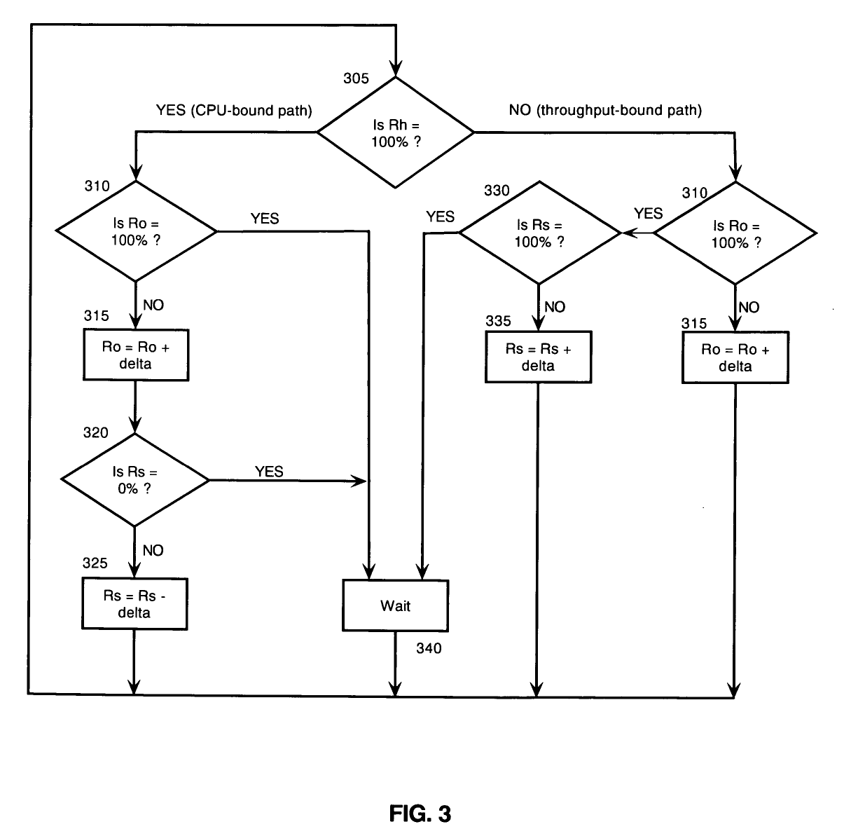

In further illustration, FIG. 3 is a flow chart illustrating a process for selecting between separate hardware implemented and software implemented iSCSI paths to process an input/output request of FIG. 1. Beginning in decision block 305 the percent (%) utilization of the host CPU 101 (e.g., the percentage of processor cycles utilized to process instructions) is determined to see if Rh is at 100% (i.e., full utilization). If so, in block 310, the percent (%) utilization of the adapter processor 145 (e.g., the percentage of processor cycles utilized to process instructions) is determined to see if Ro is at 100% (i.e., full utilization). If utilization (Ro) of the offloaded processor 145 is 100% then in block 340, the system can wait until either Rh or Ro is no longer to at 100% utilization to process the pending request. If utilization (Ro) of the offloaded processor 145 is less than 100% then in block 315, after the request is processed, utilization (Ro) of the offloaded processor 145 can be increased by factor of delta (which is a tunable parameter that determines how quickly to ramp up or ramp down Rh, Ro and Rs). In decision block 320, if the utilization (Rs) of the SW initiator (Gb Ethernet NIC card 135) is not at 0%, utilization (Rs) of the SW initiator (Gb Ethernet NIC card 135) can be decreased by a by factor of delta. In this embodiment, the utilization (Rs) of the Gb Ethernet NIC card 135 relates directly to the host CPU 101.

Referring back to decision block 305, if the percent (%) utilization Rh of the host CPU 101 is determined not to be at 100% (i.e., full utilization), then in block 310, the percent (%) utilization of the adapter processor 145 is determined to see if Ro is at 100% (i.e., full utilization). If utilization (Ro) of the offloaded processor 145 is not at 100% then in block 315, after the request is processed, utilization (Ro) of the offloaded processor 145 can be increased by factor of delta. Otherwise, in decision block 320, if the utilization (Rs) of the SW initiator (Gb Ethernet NIC card 135) is not at 100%, utilization (Rs) of the SW initiator (Gb Ethernet NIC card 135) can be increased by a factor of delta. Although it has been illustrated in the preceding embodiment that the HW iSCSI implementation is to be maximized in terms of Ro utilization, the invention is not limited to this embodiment. In other alternative embodiments, the utilization preferences can be set to any duty cycle desired. In fact, a single request can be partially processed by a first iSCSI implementation in the host and partially processed by a second iSCSI implementation in the adapter based on a value of the utilization of the first processor in the host and a value of the utilization of the second processor in the adapter.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code can be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A data input/output request processing method comprising:
selecting between separate hardware implemented and software implemented Internet Small Computer System Interface (iSCSI) paths to process an input/output request.

2. The method of claim 1, wherein the selecting between separate hardware implemented and software implemented iSCSI paths to process an input/output request, comprises:
transmitting a stream of requests to access at least one logical block address in at least one storage device in an IP storage system;
monitoring a utilization of a first processor in a host configured to transmit the stream of requests, wherein the host comprises a first iSCSI implementation;
monitoring a utilization of a second processor in an adapter coupled to the storage device, wherein the adapter comprises a second iSCSI implementation; and
routing requests in the stream of requests to the first iSCSI implementation in the host and the second iSCSI implementation in the adapter based on a value of the utilization of the first processor in the host and a value of the utilization of the second processor in the adapter; wherein the first iSCSI implementation is a software iSCSI, wherein the second iSCSI implementation is a hardware iSCSI.

3. The method of claim 2, further comprising:
determining if the first processor in the host is fully utilized.

4. The method of claim 3, further comprising:
determining if the second processor in the adapter is fully utilized responsive to determining that the first processor is fully utilized.

5. The method of claim 4, further comprising:
routing the requests to the adapter to be serviced by the second iSCSI implementation responsive to determining that second processor is not fully utilized.

6. The method of claim 3, further comprising:
determining if the second processor in the adapter is fully utilized responsive to determining that the first processor is not fully utilized.

7. The method of claim 6, further comprising:
routing the requests to the adapter to be serviced by the second iSCSI implementation responsive to determining that the second processor is not fully utilized.

8. The method of claim 7, further comprising:
routing the requests to the host to be serviced by the first iSCSI implementation responsive to determining that the second processor is fully utilized.

9. The method of claim 2, wherein the value of the utilization of the first processor in the host is based on a value of utilization of a processor in an Ethernet network interface card.

10. A data input/output request processing system for selecting between separate hardware implemented and software implemented iSCSI paths to process an input/output request, the system comprising:
a host; and,
iSCSI monitor control logic coupled to the host wherein the iSCSI monitor control logic comprises program code enabled to select between separate hardware implemented and software implemented iSCSI paths to process an input/output request.

11. The data processing system of claim 10, further comprising:
an adapter coupled to the host to provide a hardware iSCSI path.

12. A computer program product comprising a computer usable medium having computer usable program code data input/output request processing, the computer program product including:
computer usable program code for selecting between separate hardware implemented and software implemented iSCSI paths to process an input/output request.

13. The computer program product of claim 12, wherein the computer usable program code for selecting between separate hardware implemented and software implemented iSCSI paths to process an input/output request, comprises:
computer usable program code for transmitting a stream of requests to access at least one logical block address in at least one storage device in an IP storage system;
computer usable program code for monitoring a utilization of a first processor in a host configured to transmit the stream of requests, wherein the host comprises a first iSCSI implementation;
computer usable program code for monitoring a utilization of a second processor in an adapter coupled to the storage device, wherein the adapter comprises a second iSCSI implementation; and,
computer usable program code for routing requests in the stream of requests to the first iSCSI implementation in the host and the second iSCSI implementation in the adapter based on a value of the utilization of the first processor in the host and a value of the utilization of the second processor in the adapter; wherein the first iSCSI implementation is a software iSCSI, wherein the second iSCSI implementation is a hardware iSCSI.

14. The computer program product of claim 13, further comprising:
computer usable program code for determining if the first processor is fully utilized.

15. The computer program product of claim 14, further comprising:
computer usable program code for determining if the second processor in the adapter is fully utilized responsive to determining that the first processor is fully utilized.

16. The computer program product of claim 15, further comprising:
computer usable program code for routing the requests to the adapter to be serviced by the second iSCSI implementation responsive to determining that the second processor is fully utilized.

17. The computer program product of claim 14, further comprising:
computer usable program code for determining if the second processor in the adapter is fully utilized responsive to determining that the first processor is not fully utilized.

18. The computer program product of claim 17, further comprising:
computer usable program code for routing the requests to the adapter to be serviced by the second iSCSI implementation responsive to determining that the second processor is not fully utilized.

19. The computer program product of claim 18, further comprising:
computer usable program code for routing the requests to the host to be serviced by the first iSCSI implementation responsive to determining that the second processor is fully utilized.
